(19) United States
(12) Patent Application Publication
(10) Pub. No.: US 2007/0225188 A1
(43) Pub. Date: Sep. 27, 2007

(54) Remover solution composition and use thereof

(75) Inventor: Hsing-Chia Wang, Hsinchu (TW)

Correspondence Address: Ladas & Parry, 26 West 61st Street, New York, NY, 10023, US

(73) Assignee: DAXIN MATERIALS CORPORATION

(21) Appl. No.: 11/725,887

(22) Filed: Mar. 20, 2007

(30) Foreign Application Priority Data
Mar. 21, 2006 (TW) 095109685

(51) Int. Cl. C11D 7/32

(52) U.S. Cl. 510/175

(57) ABSTRACT

The invention provides a remover solution composition, comprising:
(A) 0˜25% by weight of an alkaline compound;
(B) 0.1˜20% by weight of an alcohol amine compound;
(C) 0.5˜20% by weight of a surfactant;
(D) 3˜80% by weight of a water-miscible solvent; and
(E) water.

The remover solution composition of the invention is suitable for removing unnecessary photoresists or planarization materials on edges of substrates of display panels or color filters.

### BACKGROUND OF THE INVENTION

1. Field of the Invention

The present invention relates to a remover solution composition, which is suitable for removing unnecessary photoresists or planarization materials on the edges of the substrates of display panels or color filters.

2. Description of the Prior Art

In general, a photoresist or heat-curable material is coated on a silicon wafer or a glass substrate by dispersing the photoresist on the surface of the substrate with a centrifugal force in a rotary manner, and after being coated, the top, periphery, side edge, and back surface of the substrate are all attached with the photoresist. The thickness of the coating layer at the center of the top surface of the substrate is uniform, while a peripheral protrusion will occur at the periphery of the top surface, and a side edge attachment and a back attachment will occur individually on the side edge and the back surface of the substrate. With regard to the function of the photoresist, the peripheral protrusion, the side edge attachment, and the back attachment are undesired, and the photoresist at these places will become fragile after a prebaking treatment, and tend to be peeled into flakes during the transportation of the substrates. The above-described peeled flakes of the photoresist will be a source of foreign substances in the devices, and result in a decreased yield in the manufacture of LCDs; and sometimes in the course of exposure, they will attach to a mask and result in an increase in the frequency of cleaning the mask and thus a decrease in the production capacity. If the photoresist material is colorful, the material may cover the alignment mark and result in the failure of being aligned in the exposure or other post-processes.

Therefore, to overcome the above-described disadvantages, after the photoresist is coated, the protrusion on the periphery of the substrate normally will be cleaned up before the exposure imaging and other post-processes. JP 63-69563 and JP 2950407 have disclosed using a solvent and a mixture of solvents to clean up the undesired photoresist in the forms as the peripheral protrusion, the side attachment, and the back attachment.

However, the above-described solvents are not good for the removal of a photoresist or heat-curable material. There are still photoresist residues left. Moreover, some solvents even encounter the problems associated with toxicity, environmental contamination and a lower flashing point. Also, this solvent-type remover often causes an abnormal protrusion at the cleaned interface after the edge is cleaned by the remover, thus resulting in a reduced yield in the post-processes. The current solution utilized in the art is to use water as a dispersing medium. As disclosed in ROC Patent Publication No. 574604, this type of aqueous remover solution has the advantages associated with a low toxicity, a non-ignitability, an ease to be handled, a simple waste treatment, and a lower cost. However, for some photoresists or planarization materials, this type of aqueous remover solution may cause interface swelling and protrusion, and the protrusion cannot be eliminated completely at the development stage, thus resulting in residues and leading to a decreased product yield.

Since the removers play an important role in liquid crystal panel process or color filter process, the above-described remover solutions may provide some effects, but cannot meet various demands completely. In order to obtain a remover solution that can remove effectively unnecessary photoresists or planarization materials on the edges of the substrates of display panels or color filters, the inventors have found upon an extensive research that by selecting a solvent that is highly compatible with water may be chosen to mix with water phase as dispersing medium in a remover solution composition, which would not cause residual phenomenon of development. Moreover, the removing effect of this system of partial water and partial solvent is better than that of the system with solvent only, and this system can reduce the cost of starting materials, thus the above-described purposes of the invention can be achieved.

### SUMMARY OF THE INVENTION

The object of the present invention is to provide a remover solution composition comprising:

(A) 0˜25% by weight of an alkaline compound;

(B) 0.1˜20% by weight of an alcohol amine compound;

(C) 0.5˜20% by weight of a surfactant;

(D) 3˜80% by weight of a water-miscible solvent; and

(E) water.

The composition of the present invention has the advantages of achieving a good removing effect, leaving little residues, having low toxicity, and resulting in only little environmental contamination.

### DETAILED DESCRIPTION OF THE INVENTION

The alkaline compounds that can be used in the remover solution composition of the present invention are not particularly limited and are well known to those of ordinary skill in the art, which include inorganic bases, such as, potassium hydroxide, sodium hydroxide, sodium carbonate, sodium bicarbonate, potassium carbonate, and potassium bicarbonate; and organic bases, such as, quaternary ammonium salts, of which the quaternary ammonium salts are preferred. Examples of the quaternary ammonium salts include quaternary ammonium hydroxides, which can be selected from tetramethyl ammonium hydroxide (TMAH), 2-hydroxyltrimethyl ammonium hydroxide, tetraethyl ammonium hydroxide (TEAH), tetrapropyl ammonium hydroxide (TPAH), or tetrabutyl ammonium hydroxide (TBAH), or a mixture thereof. The quaternary ammonium hydroxide preferably is tetramethyl ammonium hydroxide or 2-hydroxyltrimethyl ammonium hydroxide, and more preferably tetramethyl ammonium hydroxide.

The alkaline compound used in the present invention is present in an amount of 0˜25% by weight, preferably 0.5˜10% by weight, and more preferably 2˜10% by weight on the basis of the total weight of the composition.

The alcohol amine compounds that can be used in the remover solution composition of the present invention are not particularly limited and are well known to those of ordinary skill in the art, which include, for example, monoethanolamine (MEA), diethanolamine, triethanolamine, 2-(2-aminoethoxy)ethanol, monoisopropanolamine, diisopropanolamine, triisopropanolamine, N-ethylethanolamine, and N-butyl ethanolamine, and a mixture of two or more of these alcohol amines.

The alcohol amine compound used in the present invention is present in an amount of 0.1˜20% by weight, preferably 0.2˜10% by weight, and more preferably 1˜8% by weight on the basis of the total weight of the composition.

The surfactants that can be used in the present invention are well known to those of ordinary skill in the art, which, for example, include nonionic surfactants, cationic surfactants, anionic surfactants, and ampholytic surfactants, of which the nonionic surfactants, such as, polyoxyethylene alkyl ether, polyoxyethylene alkyl aryl ether, sorbitan fatty acid ester, polyoxyethylene sorbitan fatty acid ester, fatty acid monoglyceride, and ethylene oxide/propylene oxide copolymer, are preferred. Examples of commercial nonionic surfactants include the surfactants manufactured by Dow Chemical Co. under the trade names of TritonX-100®, TritonX-405®, and TritonX-114®. The surfactants may prevent the liquid crystal from being contaminated by the composition, and meanwhile provide a good wetting property to the photoresist. According to an embodiment of the present invention, the surfactant is used in an amount of 0.5˜20% by weight on the basis of the total weight of the composition.

The solvents that can be used in the present invention include those highly compatible with water, which are, for example, N-methyl pyrrolidone (NMP), methyl ethyl ketone (MEK), acetone, cyclohexanone, dimethyl sulfoxide (DMSO), ethylene glycol monomethyl ether, ethylene glycol monoethyl ether, diethylene glycol monomethyl ether, diethylene glycol monoethyl ether, diethylene glycol butyl ether, and propylene glycol methyl ether (PGME), and a mixture thereof. The solvent is preferably propylene glycol methyl ether, dimethyl sulfoxide or a mixture thereof, more preferably propylene glycol methyl ether. The solvent used in the present invention is present in an amount of 3˜80% by weight, preferably 10˜60% by weight, and more preferably 10˜40% by weight on the basis of the total weight of the composition.

The remover solution of the present invention can be used to remove unnecessary photoresists or planarization materials from the edge of a display panel or the substrate of a color filter. The photoresist described above includes color photoresist, black photoresist, and photo spacer photoresist. The planarization materials described above can be used as a surface protection layer for the color filter to avoid the color mixing among the red, green, and blue color materials, prevent the color filter from unnecessary damages in the subsequent processes, and meanwhile eliminate the height difference between the color material films and the masking layer by planarization. The planarization materials include thermally curable resins and photosensitive resins. There are no particular limitations on the photosensitive resins, which may be positive or negative photosensitive resin compositions. In general, a photosensitive resin composition comprises an alkaline soluble binder resin, a photosensitive compound, a photo initiator, and a solvent. The remover solution of the present invention is especially suitable for removing the unnecessary photo spacer photoresists and planarization materials.

### EXAMPLE

The following example will further illustrate the present invention, but is not intended to limit the scope of the invention. Any modifications and variations achieved by persons skilled in the art without departing from the spirit of the invention are within the scope of the invention.

### [Evaluation of the Remover Solution]

Cleaning Effect: A photoresist was coated on a glass substrate by a centrifugal force in a rotary manner, after this, the edge part of the substrate was immersed in the remover solution for 10 seconds, and then rinsed with water. Subsequently the photoresist layer on the substrate edge after being washed was observed visually to determined whether it is a straight line or not.

◯: linearity is good

Δ: linearity is poor

x: edge-removing effect is not good

Residues: A 50× microscope was used to observe whether there were residues at the washed site on the above-mentioned glass substrate after being washed with an edge bead remover (“EBR”); or observe the residues by the above-described method after an exposure development process.

◯: No residues

x: Some residues

Swelling Property: It was determined by a stylus surface profiler (Tencor α-500surface scan). The increasing percentages in thickness of the cleaned cross-section of the film and the inner side of the film were calculated.

◯: the increasing percentage is <5%

x: the increasing percentage is >5%

### Example 1

A spacer photoresist was coated on a 10 cm×10 cm glass substrate with a centrifugal force in a rotary manner, and then dried for 10 seconds in a vacuum of 10⁻² torr. Thereafter, the edge portion of the substrate, which had not been exposed, was immersed in a remover solution for about 10 seconds to remove the protrusion on the periphery of the substrate, and then washed with water. The physical properties of the washed substrate are shown in Table 1. And, the edge of the substrate was viewed with a microscope, so as to confirm that the washing effect was good, and there were no residues, and a swelling effect would not occur for the photoresist at the interface position, thus avoiding the impossible removal of the photoresist residues after development. Afterwards, this material was exposed with an exposer (150 mJ/cm²) and developed for 60 seconds with a KOH-type developing solution. The contact interface (non-exposed position) of the spacer photoresist and the EBR remover solution on the substrate was viewed with a microscope. The result indicates that there were no residues.

### Examples 2˜4 and Comparative Examples 1˜10

The same operation manner as used in Example 1 was employed except that different remover solutions having different components as shown in Table 1 were used. The results are shown in Table 1.

TABLE 1
Components and experimental results for the remover solutions of the examples of the present invention and
the comparative examples

| | | | | | | | Properties | | | |
|---|---|---|---|---|---|---|---|---|---|---|
| | | | | | | | Residues | Residues | | |
| | | Components of Remover Solution (% by weight) | | | | | after | after | | |
| | | Solvent | | | Alcohol | | being | exposure | | |
| | | Organic | | Alkaline | amine | | washed | and | Swelling | |
| | No. | solvent^{(a)} | Water | compound^{(b)} | compound(c) | Surfactant^{(d)} | with EBR | development | property | Linearity |
| Examples | 1 | 30 | 51 | 8 | 6 | 5 | ∘ | ∘ | ∘ | ∘ |
| | 2 | 50 | 23 | 0 | 15 | 12 | ∘ | ∘ | ∘ | ∘ |
| | 3 | 40 | 42 | 12 | 1 | 5 | ∘ | ∘ | ∘ | ∘ |
| | 4 | 10 | 64 | 8 | 8 | 10 | ∘ | ∘ | ∘ | ∘ |
| Comparative | 1 | 0 | 74 | 8 | 8 | 10 | ∘ | x | x | ∘ |
| Examples | 2 | 40 | 47 | 8 | 0 | 5 | x | ∘ | ∘ | x |
| | 3 | 40 | 45 | 10 | 5 | 0 | x | ∘ | ∘ | x |
| | 4 | 40 | 14 | 8 | 8 | 30 | ∘ | x | x | x |
| | 5 | 40 | 10 | 30 | 10 | 10 | ∘ | x | x | x |
| | 6 | 40 | 10 | 10 | 30 | 10 | ∘ | x | x | ∘ |

^{(a)}PGME(Dow Chemical)
^{(b)}TMAH(Kemitek Industrial Corp.)
^{(c)}MEA(Oriental Union Chemical Corp.)
^{(d)}Triton X-100(Dow Chemical)

What is claimed is:

1. A remover solution composition comprising:
(A) 0˜25% by weight of an alkaline compound;
(B) 0.1˜20% by weight of an alcohol amine compound;
(C) 0.5˜20% by weight of a surfactant;
(D) 3˜80% by weight of a water-miscible solvent; and
(E) water.

2. The remover solution composition according to claim 1, wherein the alkaline compound is a quaternary ammonium salt.

3. The remover solution composition according to claim 2, wherein the alkaline compound is tetramethyl ammonium hydroxide.

4. The remover solution composition according to claim 1, wherein the alkaline compound is used in an amount of 2 to 10% by weight.

5. The remover solution composition according to claim 1, wherein the alcohol amine compound is selected from the group consisting of ethanolamine, diethanolamine, triethanolamine, 2-(2-aminoethoxy)ethanol, monoisopropanolamine, diisopropanolamine, triisopropanolamine, n-ethylethanolamine, n-butyl ethanolamine and a mixture thereof.

6. The remover solution composition according to claim 1, wherein the alcohol amine compound is used in an amount of 1 to 8% by weight.

7. The remover solution composition according to claim 1, wherein the surfactant is a nonionic surfactant.

8. The remover solution composition according to claim 1, wherein the solvent is N-methylpyrrolidone, methyl ethyl ketone, acetone, cyclohexanone, dimethyl sulfoxide, ethylene glycol monomethyl ether, ethylene glycol monoethyl ether, diethylene glycol monomethyl ether, diethylene glycol monoethyl ether, diethylene glycol butyl ether, or propylene glycol methyl ether, or a combination thereof.

9. The remover solution composition according to claim 1, wherein the solvent is propylene glycol methyl ether.

10. The remover solution composition according to claim 1, wherein the solvent is used in an amount of 10 to 40% by weight.

11. A method for removing unnecessary photoresist or planarization material on the edge of a substrate of a display panel or color filter, comprising using the remover solution composition according to claim 1.

12. The method according to claim 11, wherein the photoresist is a photo spacer photoresist.
